(19) United States
(12) Patent Application Publication
(10) Pub. No.: US 2002/0176388 A1
(43) Pub. Date: Nov. 28, 2002

(54) Beacon update mechanism

(76) Inventors: Paul J. Rankin, Horley (GB); Paul R. Simons, Redhill (GB)

Correspondence Address: PHILIPS ELECTRONICS NORTH AMERICAN CORP, 580 WHITE PLAINS RD, TARRYTOWN, NY, 10591, US

(21) Appl. No.: 10/101,326

(22) Filed: Mar. 19, 2002

(30) Foreign Application Priority Data
Mar. 20, 2001 (GB) 0106846.9
Oct. 25, 2001 (GB) 0125599.1

(51) Int. Cl. H04Q 7/24

(52) U.S. Cl. 370/338; 370/328

(57) ABSTRACT

A communications network comprises a plurality of beacons (10) for transmitting data to mobile receivers within range, each beacon (10) storing local data items for transmission to the mobile receivers which is dependent on the location of the beacon. A central controller (14) is provided for updating the local data items stored in the beacons. The central controller (14) enables beacons to be identified which require updating in response to a desired change in a local data item. This system uses a central controller that can manage the control and configuration and software running on the remote beacons. The central controller can efficiently monitor and control the content information running on each beacon to ensure the network is providing up-to-date alerts and messages to users.

The present invention relates to mobile communications devices, such as telephones and suitably equipped personal digital assistants (PDA's), and to infrastructure systems and protocols for use with the same.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. “Context-Aware” (CA) mobile telephones are expected to be used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

One possible example of signalling protocol is Bluetooth. One issue with Bluetooth is the long call set-up procedure, which prevents data communication in a short space of time. It has been proposed by the applicant to broadcast data before a connection is made according to Bluetooth protocols, so as to avoid the long call set-up procedure. This can be achieved by exploiting the Bluetooth Inquiry phase by extending the very short ID packet sent out during this mode and using the extra space thus gained to carry a small amount of information. This information can be Bluetooth system related data or one-way application data. This scheme has the potentially useful feature of being backwards-compatible with legacy Bluetooth devices that are not able to understand this extra field.

Broadcasting content and pushed services using IR or RF beacons are expected to become more common as wireless connectivity increases with the advent of a range of small handsets and RF technologies, such as Zigbee, 802.11 and Bluetooth. The configuration of such beacons is analogous to the control of a cellular network of base-stations, sharing many of the same operational problems, for instance the:

Central control of a network

Configuration to achieve maximum coverage power requirements, bandwidth and load handling with multiple handsets.

However, in the domain of short range RF beacons there are a number of key differences, since the beacons must not just be regularly (re) configured from a system point of view, but must also contain locally relevant and up-to-date content for the beacon broadcast. This application addresses the requirement to centrally manage this new updating process.

According to the invention, there is provided a communications network comprising:

a plurality of transmitters, each for transmitting data to mobile receivers within range of the transmitter, each transmitter storing local data items for transmission to the mobile receivers which is dependent on the location of the transmitter; and

a central controller for updating the local data items stored in the transmitters of the network,

wherein the central controller comprises means for identifying the local data stored within each transmitter, thereby enabling transmitters to be identified which require updating in response to a desired change in a local data item.

This system uses a central controller that can manage the control and configuration and software running on the remote transmitters (beacons). In addition to controlling update of the local data items (i.e. content to be broadcast) stored in the transmitter, the central controller can control the configuration and roles in protocol handling of a large number of transmitters either operating independently or as part of a network. By storing means for identifying the local data stored within each transmitter, the central controller can efficiently monitor and control the content information running on each transmitter to ensure the network is efficiently providing up-to-date alerts and messages to users.

Such a central control system may be entirely automatic or support user interfaces for human operators to overview activity and status, and to manually issue update commands.

Each transmitter may also be reconfigurable to adapt to changing requirements such as the broadcasting mode (if different transmission modes are supported), the status of the beacon (i.e. on or off), the RF protocol used, discoverability levels, bandwidth, transmission frequency and handshaking protocols. The software version running at the transmitter can also be upgraded or patched.

Each transmitter may comprise a transceiver enabling bidirectional system communication between the transmitter and the central controller. This then allows the central controller to provide the required updated local data or re-configuration commands to each transmitter, and receive status information from the transmitter. The bi-directional system communication may be using a mobile telephony connection, such as GSM, giving the required reach from the central controller to all transmitters.

Each transmitter may comprise a transceiver enabling bidirectional client communication between the transmitter and the mobile receivers. This enables the transmitters to send information (the local data items) to the mobile receivers, and then allows the mobile receivers to respond, for example to enable the user of the mobile receiver to request further information. This may then lead to a direct connection between the transmitter and the mobile receiver. Services can also be delivered via connectionless broadcast.

The central controller preferably comprises a database identifying all local data items stored in each transmitter.

Instead of the central controller sending updates to all transmitters, the transmitters may be arranged within range of at least one other transmitter such that update messages can be passed or relayed between transmitters. This enables only one transmitter to be provided with the GSM or other telephony link to the central controller, and enables the information then to pass between the transmitters using the Bluetooth or other local-RF protocols.

The invention also provides a method of controlling a communications network comprising:

providing a plurality of transmitters with software comprising local data items selected in dependence on the location of the transmitter and for transmission to mobile receivers within range of the transmitter; and

subsequently identifying in a central controller the transmitters of the network which require updating as a result of updates to local data items; and

transmitting updated local data items to the identified transmitters.

This method provides the centralised updating of local data stored in the transmitters, as discussed above.

The identification may be carried out in response to an update in a local data item or else periodically.

The method may be implemented in software, and the invention provides the computer program code means for performing the method.

Examples of the invention will now be described in detail with reference to the accompanying drawings, in which:

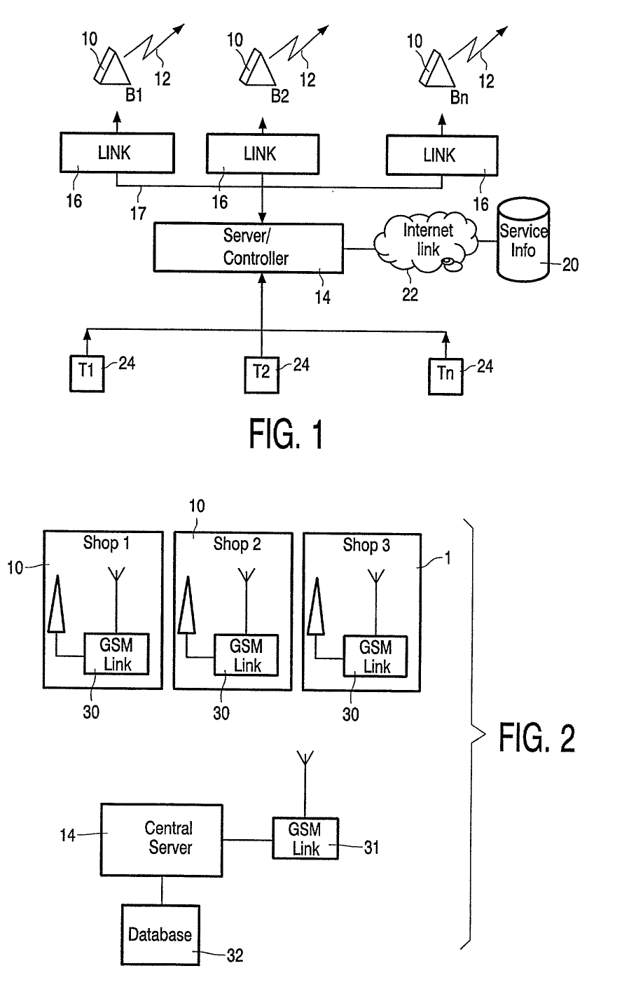

FIG. 1 shows a first example of communications network in accordance with the invention;

FIG. 2 shows a second example of communications network in accordance with the invention; and

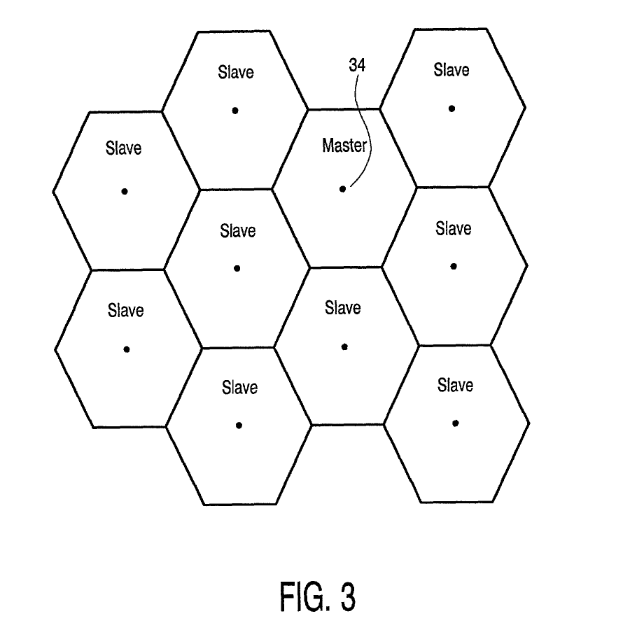

FIG. 3 is used to explain the use of multiple beacons.

FIG. 1 shows a system in which a number (B1-Bn) of beacons 10 are provided. These beacons comprise transmitters for sending data 12 to mobile receivers within range of the beacons 10. A central control system 14 manages the control and configuration and software running on the remote beacons 10. The central control system 14 communicates with the beacons over respective links 16 and back-end network 17 which allows bidirectional communication between the central control system 14 and the beacons 10.

The central control system 14 can control the configuration, roles in protocol handling, status (for example certain beacons may be turned on or off to save power consumption at the beacon or the mobile) and the content being broadcast by a large number of beacons 10 either operating independently or as part of a network. The configuration control may also include commands to the beacons to report back to the centre the Ids of discovered mobile devices or suppress such information feedback.

Each transmitter stores local data items for transmission to the mobile receivers, which data is dependent on the location of the transmitter. For example, these local data items may relate to shops in the vicinity of the beacon 10, for example giving information relating to current special offers or sales. The central control system 14 updates the local data items stored in the transmitters of the network, and keeps a log of the configurations of all of the beacons 10 of the network.

When local data is to be updated, this updated information is provided to the central control system 14. There are numerous ways to achieve this. For example, a local service provider may send information from a remote source 20 to the central beacon control system over the Internet 22. Additionally or alternatively, the central control system 14 may be wired to authoring terminals 24 at which beacon owners may update their assigned beacon configurations.

The central controller includes a database which keeps a record of the versions of the local data stored within each beacon and the status of each beacon and the times these were refreshed or monitored. In this way, when local data is updated in the central control system by the beacon owner, the system 14 can identify that certain beacons are provided with out of date software. In response to this, beacon update messages are transmitted to the beacons.

The communication between the central control system 14 and the beacons may be by a variety of systems. For example, they may all be hard wired to form a WAN or LAN network or an EXPLAN system. Alternatively, an intermittent cellular or satellite radio communication link may be established (such as GSM or UMTS).

The beacons 10 may communicate with the mobile receivers using any short range RF system, or even an IR system. Ideally, alerts should be sent from the beacons in a connectionless manner. In one example, the Bluetooth protocol can be employed. The normal bluetooth system requires a long call set up procedure to join a piconet. The time taken to join a piconet is often longer than the time a user will be within range of a beacon. The applicant has therefore devised a modification to the Bluetooth system to enable the connectionless broadcast of short messages from Bluetooth beacons. This can be achieved by exploiting the Bluetooth Inquiry phase by extending the very short ID packet sent out during this mode and using the extra space thus gained to carry a small amount of information. This information can be Bluetooth system related data or one-way application data. This scheme has the potentially useful feature of being backwards-compatible with legacy Bluetooth devices that are not able to understand this extra field.

This extra field in this example is used to carry short alert messages, for example “25% off selected CDs at Records Store X”.

Other RF technologies such as Zigbee or 802.11 also support such connectionless broadcasting modes.

In response to this alert, the mobile user may want more information. This additional information may also be stored at the beacon and fetched from the central system, or else it may require the user to make a connection to another information source, for example activating a WAP link, using a URL given to the user on the Internet, or connecting a voice telephone call to a specified number.

In the example of FIG. 1, updates under the control of the central control system are via a remote link that can be used to update each device, so that the content, configuration and software is kept up-to-date. The updating also needs to be efficient, and the beacon hierarchy and network arrangement can be used to propagate onwards configuration changes. As mentioned above, the remote link or back channel 17 can either be wired e.g. LAN/WAN/PLC or an unwired link e.g. 802.11 wireless LAN, GSM, UMTS and satellite radio. It may also be done via the short range RF technology such as Bluetooth itself. This requires all beacons to be reachable via other beacons over Bluetooth by overlapping Bluetooth coverage. A protocol/mechanism is then required to configure a number of remote beacons, or a network of beacons, and also to verify beacons are working and have been updated.

As will be recognised, some of these re-configuration requirements may also be applied to other RF or IR beacon network technologies such as IRda and Home RF (now termed “Zigbee” or 802.15.4).

The central control system maintains a database of the status, protocol configuration, content and contact number of each beacon under its control. Some information on the beacons can remain static, whereas other information is dynamic. When any dynamic content/configuration/software is updated the database is searched to identify which beacons require updating and an update schedule is produced to perform this task automatically. Changes may be propagated or relayed from one beacon onto other beacons over their back-channel to reduce the traffic to the central controller. Beacon device ID's may be logically grouped, so that a whole group is updated by group commands. The back-end network 17 from beacons to the central controller may be a variety of different technologies as mentioned above, for example Zigbee, Bluetooth, 802.11, wired or wireless LAN or a mixture of these.

Using the schedule the server can contact beacons over the back channel to download the new data. The server can also instruct tests to be performed to verify beacon operation and download to the centre a log of transactions processed and the mobile device identifiers discovered.

The control scheme enables:

Central control of beacons

Automatic configuration for efficiency and accuracy of updating

Remote beacons to be configured easily

Software to be updated remotely

Tests to be performed on correct beacon operation

Allows transaction log to be uploaded for analysis—this can be used to verify effectiveness and success rate of beacon.

A simple specific implementation of this invention shown in FIG. 2 is a number of isolated Bluetooth beacons 10, each with a GSM downlink 30 to the central control system 14, which also has a GSM link 31 and a database 32. The beacons 10 form a small chain of shops. The GSM connection allows a data channel back to the central server where the broadcast content can be created and managed for the whole chain of shops as shown in the diagram. At regular intervals or when specific data has been updated, the central control system (server) and beacons can make a connection to download new data. The connection can also upload a transaction data log from the beacon, perform tests and verify its correct operation.

The central control system can be controlled by an update schedule which holds a database about all software versions and content running on each beacon 10 that it controls. When software or content is updated and published, the updated schedule will be reviewed to see if any beacons need updating. If so, a remote connection is established to download the new data.

In the example below, a database holds information relating to the configuration, software and content in each beacon. If the content PR32 (containing details of a particular set of offers) is updated, the automatic update facility knows to update the content of beacons 14402 and 10596.

| | | Beacon | Software | |
|---|---|---|---|---|
| Beacon ID | Location | Config' | Version | Applications |
| 12112 | Crawley | Inquirer | IQ2.2 | |
| 14402 | Crawley | Interactor | IN3.2 | PR32, PR45 |
| 15103 | Redhill | Inquirer | IQ2.2 | |
| 18504 | Redhill | Interactor | IN3.2 | PR03, PR65 |
| 10596 | Copthorne | S/B | SB2.6 | PR32, PR33 |
| 11675 | Three | S/B | SB2.6 | PR45 |
| | Bridges | | | |
| 19463 | Kings Lynn | C/B | SB2.6 | PR17, PR65 |
| 21426 | Darford | Inquirer | IQ2.2 | |

In the table above, some beacons are identified as “Interactor” and some are identified as “Inquirer”. Some beacons are also identified as connectionless broadcast (C/B) and other are identified as Split Beacons (S/B). This relates to a specific Bluetooth network configuration in which one or more beacons 10 are labelled as an ‘inquirer’ beacon, and arranged to send out Bluetooth inquiry messages constantly. The (or each) other beacons are labelled as ‘interactor’ beacons and allowed to communicate with terminals 10 on a one-to-one basis on request. Here, the inquiry procedure is performed by an inquirer beacon and the paging procedure by an interactor beacon. By delegating the functions this way, it is possible to save a considerable amount of time that would otherwise be lost in attempts to join piconets.

In this arrangement, the inquirer beacon constantly transmits inquiry packets which are used to discover the identities of any clients—portable devices—in range of the beacon. Once a client comes into range, it will respond to the inquiry, giving the inquirer information about its identity.

The information about the client discovered is then transmitted over a secure channel (typically over fixed infrastructure) to the interactor beacon—a beacon solely concerned with transmitting information to the client. This then begins service interaction by issuing a page message containing the client's identity to which the client will respond.

Although the client is obliged to go through the inquiry and paging processes, the fact that the inquirer can issue inquiry packets continuously makes the process much quicker. The use of a separate beacon for all interactions means that the inquirer does not have to pause to issue page messages, nor does it have to stop to allow interactive traffic. The client therefore never has to wait for the inquirer to enter inquiry mode. This in itself is a significant saving of time. As an added bonus, the interactor beacon does not have to wait for an Inquiry cycle to complete before issuing a page message and some seconds can be saved here as well.

The invention can be extended to manage beacon networks within a large store. The size of the store is such that a single beacon does not have the range to cover the whole store area, so a number of beacons are installed to cover the whole area. This is shown in FIG. 3 where each beacon is represented by a bold circle and the hexagon represents its coverage area. One beacon is designated as a Master beacon 34, and the others are slave beacons. Other propagation networks are possible as well as the hexagon, such as tree structures of beacons fanning out from a centre point.

It would be possible to allow each of the beacons to have its own GSM downlink, but such a GSM connection an expensive addition. Instead the network is arranged such that beacons are spaced to be within range of one another, but spaced to cover the maximum area. Messages can be relayed between beacons using the bluetooth link. In this way, the master beacon 32 can establish a connection with a remote central system by establishing a message that is routed via other beacons. In this case a master beacon with a GSM link can mange a whole network of interconnected beacons.

In order to do this, the master beacon receives an update signal over its GSM link. The update signal contains all the content to update its network. It also contains an ordered list of beacons to perform updates which takes into account the available connections to each beacon.

The update schedule and content is handed from one beacon to the next as content is extracted to update each beacon in turn. When each beacon has been re-configured, the schedule is updated and passed to the next beacon in the list as in a daisy-chain.

When some areas are expected to carry high loads of handset interaction, e.g. in crowded places, then the idea can further be extended to cover re-assigning the roles of the individual radios in multiple-radio beacon clusters—e.g. how many perform inquiry, how many perform interaction in the split-beacon implementation outlined above, how many are active or switched off etc.

Finally, if the expected handset flow and density patterns through a environment are expected to alter because of events, time of day (rush hour), day of week etc, then it may be necessary to re-define the ‘adjacency’ of beacons for efficient handover. At one time of the day, handsets are expected to pass beacon 3, then beacon 5, then pass beacon 7, while at other times of the day the expected hand-over might be from 3 to 7 to 5. Efficient Bluetooth hand-over and service continuity may require sending system-acquired information on clocks, handset characteristics etc from one beacon to its adjacent neighbours, as shown in FIG. 3.

The transmission from beacons to mobile handset uses a short range technology, such as IR or short range RF. Examples are Bluetooth, Zigbee, 802.11a, 802.11b and others. Indeed, the network may comprise beacons working simultaneously different RF technologies, and the central controller can then switch the modes of some of the beacons to operate on a different RF technology to optimise power consumption, bandwidth to the mobile, latency etc.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

1. A communications network comprising:
a plurality of transmitters, each for transmitting data to mobile receivers within range of the transmitter, each transmitter storing local data items for transmission to the mobile receivers which is dependent on the location of the transmitter; and
a central controller for updating the local data items stored in the transmitters of the network,
wherein the central controller comprises means for identifying the local data stored within each transmitter, thereby enabling transmitters to be identified which require updating in response to a desired change in a local data item.

2. A system as claimed in claim 1, wherein the transmitter is for transmitting using short range RF.

3. A system as claimed in claim 1, wherein each transmitter comprises a transceiver enabling bidirectional system communication between the transmitter and the central controller.

4. A system as claimed in claim 3, wherein the bidirectional system communication is using a mobile telephony connection.

5. A system as claimed in claim 4, wherein the mobile telephony connection is a cellular or satellite radio connection.

6. A system as claimed in claim 1, wherein each transmitter comprises a transceiver enabling bidirectional client communication between the transmitter and the mobile receivers.

7. A system as claimed in claim 6, wherein the bidirectional client communication is using a Bluetooth connection.

8. A system as claimed in claim 1, wherein the central controller comprises a database identifying all local data items stored in each transmitter and the operative states of each beacon.

9. A system as claimed in claim 1, wherein the transmitters are within range of at least one other transmitter such that update messages can be relayed between transmitters.

10. A system as claimed in claim 9, wherein some or all of the transmitters are within range of at least one other transmitter for short range RF communication.

11. A system as claimed in claim 1, wherein the central controller is also for updating the configurations of the transmitters.

12. A method of controlling a communications network comprising:
providing a plurality of transmitters with software comprising local data items selected in dependence on the location of the transmitter and for transmission to mobile receivers within range of the transmitter; and
subsequently identifying in a central controller the transmitters of the network which require updating as a result of updates to local data items; and
transmitting updated local data items to the identified transmitters.

13. A method as claimed in claim 12, wherein the identification is carried out in response to an update in a local data item.

14. A method as claimed in claim 12, wherein the identification is carried out periodically.

15. A method as claimed in claim 12, wherein the updated local data items are transmitted to the identified transmitters by a mobile telephony link between the central controller and the transmitters.

16. A method as claimed in claim 12, wherein the updated local data items are transmitted to the identified transmitters by a mobile telephony link between the central controller at least one transmitter, and by further wireless transmission between transmitters.

17. A method as claimed in claim 16, wherein the further wireless transmission is using Bluetooth, 802.11 or Zigbee.

18. A method as claimed in claim 12, wherein the transmitters of the network which require updating as a result of software upgrades or required configuration changes are also identified in the central controller.

19. A computer program code means for performing the method of claim 12 when run on a computer.

20. A computer readable means storing a computer program code means as claimed in claim 19.
